(19) United States
(12) Patent Application Publication
(10) Pub. No.: US 2025/0208355 A1
(43) Pub. Date: Jun. 26, 2025

(54) OPTICAL WAVEGUIDE COMPONENT

(71) Applicant: SHINKO ELECTRIC INDUSTRIES CO., LTD., Nagano (JP)

(72) Inventor: Kenji YANAGISAWA, Nagano (JP)

(21) Appl. No.: 18/987,527

(22) Filed: Dec. 19, 2024

(30) Foreign Application Priority Data
Dec. 26, 2023 (JP) 2023-218776

(51) Int. Cl. G02B 6/36

(52) U.S. Cl. CPC G02B 6/368

(57) ABSTRACT

An optical waveguide component includes optical fibers each having a first end and a second end, and a support member configured to support the optical fibers. The support member includes a base including a first surface, a first protruding portion protruding from the first surface in a first direction perpendicular to the first surface, and a second protruding portion protruding from the first surface in the first direction at a position separated from the first protruding portion. The first protruding portion includes first grooves respectively configured to accommodate the first end of each optical fiber, and the second protruding portion includes second grooves respectively configured to accommodate the second end of each optical fiber. A pitch of the second grooves is larger than a pitch of the first grooves.

### CROSS-REFERENCE TO RELATED APPLICATIONS

This application is based upon and claims priority to Japanese Patent Application No. 2023-218776, filed on Dec. 26, 2023, the entire contents of which are incorporated herein by reference.

### FIELD

Certain aspects of the embodiments discussed herein are related to optical waveguide components.

### BACKGROUND

A pitch of light emitting parts and light receiving parts included in an optical semiconductor device is smaller than a pitch of a plurality of optical fibers included in an optical fiber array used for transmitting optical signals. Accordingly, an optical waveguide component, including a plurality of optical waveguides formed of an organic resin, may be used. In this optical waveguide component, a pitch of the optical waveguides at one end thereof is equal to the pitch of the light emitting parts and the light receiving parts included in the optical semiconductor device, and a pitch of the optical waveguides at the other end thereof is equal to the pitch of the optical fibers included in the optical fiber array.

Related art include Japanese Laid-Open Patent Publication No. 2005-326602, Japanese Laid-Open Patent Publication No. 2017-167223, and International Publication Pamphlet No. WO 2022/044101, for example.

In recent years, there are increasing demands to reduce a loss of the optical signal between an optical semiconductor device and the optical fiber array.

### SUMMARY

Accordingly, it is an object in one aspect of embodiments of the present disclosure to provide an optical waveguide component capable of reducing a loss of an optical signal.

According to one aspect of the embodiments of the present disclosure, an optical waveguide component includes a plurality of optical fibers, each optical fiber of the plurality of optical fibers having a first end and a second end; and a support member configured to support the plurality of optical fibers, the support member including a base including a first surface; a first protruding portion protruding from the first surface in a first direction perpendicular to the first surface; and a second protruding portion protruding from the first surface in the first direction at a position separated from the first protruding portion, wherein the first protruding portion includes a plurality of first grooves respectively configured to accommodate the first end of each optical fiber of the plurality of optical fibers, the second protruding portion includes a plurality of second grooves respectively configured to accommodate the second end of each optical fiber of the plurality of optical fibers, and a pitch of the plurality of second grooves is larger than a pitch of the plurality of first grooves.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a perspective view illustrating an example of an optical waveguide component according to a first embodiment;

FIG. 2 is a view illustrating an example of one end surface of the optical waveguide component according to the first embodiment;

FIG. 3 is a perspective view illustrating an example of a support member according to the first embodiment;

FIG. 4 is a plan view illustrating examples of the support member and optical fibers according to the first embodiment;

FIG. 5 is a plan view illustrating an example of a usage of the optical waveguide component according to the first embodiment;

FIG. 6 is a cross sectional view illustrating the example of the usage of the optical waveguide component according to the first embodiment;

FIG. 7 is a plan view illustrating an example of an attachment tool used when attaching the optical fibers to the support member;

FIG. 8 is a plan view illustrating an example of a method of attaching the optical fibers using the attachment tool;

FIG. 9 is a cross sectional view illustrating the example of the method of attaching the optical fibers using the attachment tool; and

FIG. 10 is a perspective view illustrating the support member according to a second embodiment.

### DESCRIPTION OF EMBODIMENTS

Hereinafter, preferred embodiments of the present disclosure will be described in detail with reference to the accompanying drawings. In the specification and the drawings, those constituent elements having substantially the same functional configuration are designated by the same reference numerals, and a redundant description thereof may be omitted.

### First Embodiment

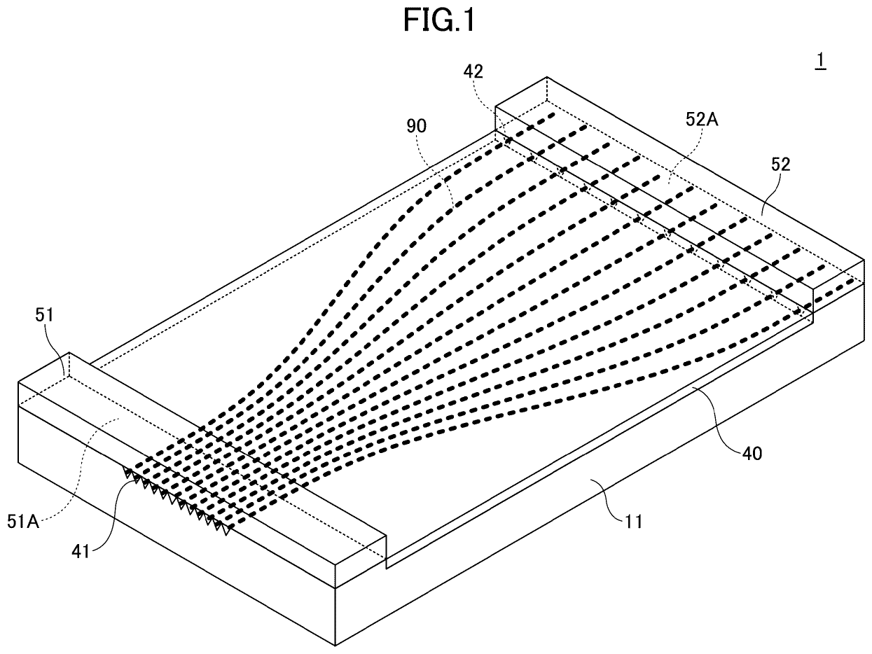

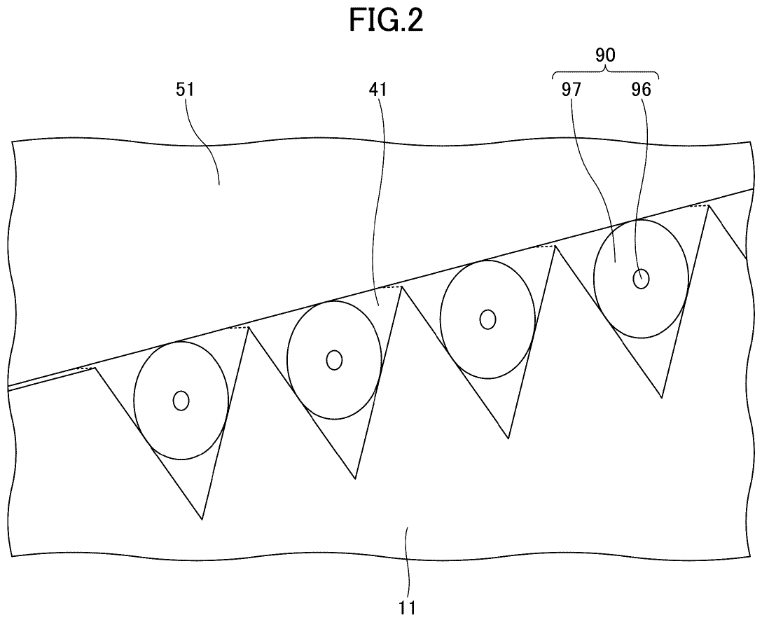

First, a first embodiment will be described. The first embodiment relates to an optical waveguide component. FIG. 1 is a perspective view illustrating an example of the optical waveguide component according to the first embodiment. FIG. 2 is a diagram illustrating an example of one end surface of the optical waveguide component according to the first embodiment.

As illustrated in FIG. 1, an optical waveguide component 1 according to the first embodiment includes a plurality of optical fibers 90, a support member 11, an organic resin layer 40, a first cover 51, and a second cover 52. For example, the plurality of optical fibers 90, the support member 11, the first cover 51, and the second cover 52 are formed of glass, such as quartz glass or the like. A diameter of the optical fiber 90 is 80 μm or less, for example, and may be 50 μm. As illustrated in FIG. 2, the optical fiber 90 includes a core 96 and a cladding 97. A diameter of the core 96 is in a range of 4 μm to 8 μm, for example.

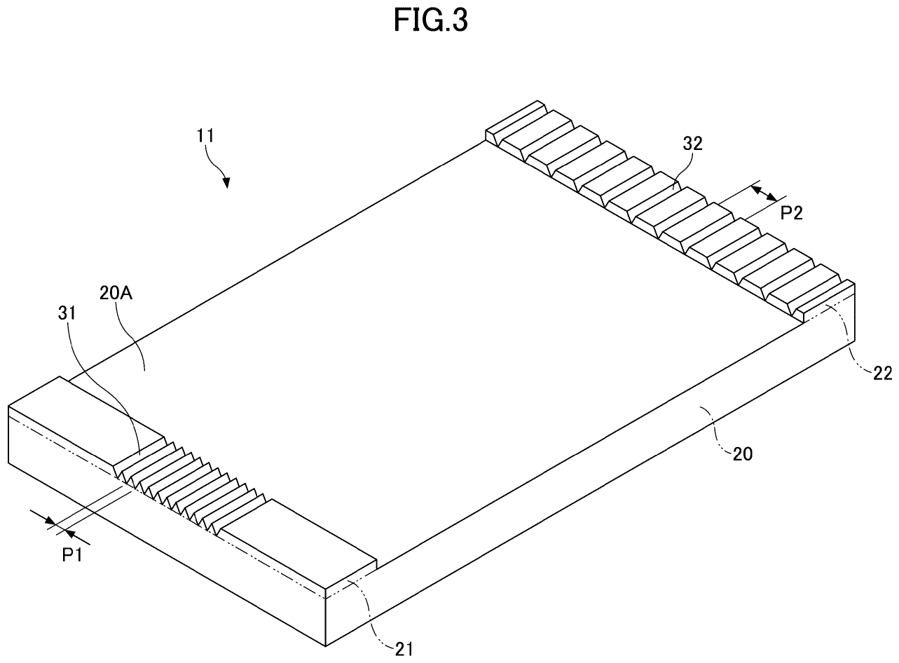

The support member 11 will be described in detail. FIG. 3 is a perspective view illustrating an example of the support member 11 according to the first embodiment.

The support member 11 includes a base 20 having a first surface 20A, a first protruding portion 21, and a second protruding portion 22. The base 20 has a flat plate shape, and has a rectangular planar shape in a plan view viewed in a direction perpendicular to the first surface 20A.

In the present embodiment, for the sake of convenience, the base 20 is used as a reference, and the first surface 20A may also be referred to as an upper side or one side, and a surface opposite to the first surface 20A may also be referred to as a lower side or the other side. The upper surface of each portion of the optical waveguide component 1 may be referred to as one surface or an upper surface, and the lower surface each portion of the optical waveguide component 1 may be referred to as the other surface or a lower surface. However, the optical waveguide component 1 can be used in an upside-down state or can be disposed at an arbitrary angle. In the present disclosure, the plan view refers to a view of an object, viewed from above, in a normal direction with respect to the first surface 20A of the base 20. The planar shape refers to a shape of the object in the plan view, viewed from above, in the normal direction with respect to the first surface 20A of the base 20.

The first protruding portion 21 is provided at one end of the base 20 in a longitudinal direction of the base 20, and protrudes in a first (or upward) direction perpendicular to the first surface 20A. For example, the first protruding portion 21 is provided to span both ends of the base 20 in the lateral (or short) direction of the base 20. The first protruding portion 21 has a substantially rectangular parallelepiped shape, and a plurality of first grooves 31 are formed in an upper surface of the first protruding portion 21. The plurality of first grooves 31 extend in parallel to the longitudinal direction of the base 20, and are arranged along the lateral direction of the base 20, for example. A pitch P1 of the plurality of first grooves 31 is in a range of 50 μm to 100 μm, for example. A cross sectional shape of the first groove 31 is a V shape having two sloping surfaces, for example.

The second protruding portion 22 is provided at the other end of the base 20 in the longitudinal direction of the base 20, and protrudes in the first (or upward) direction perpendicular to the first surface 20A. For example, the second protruding portion 22 is provided to span both ends of the base 20 in the lateral direction of the base 20. The second protruding portion 22 has a substantially rectangular parallelepiped shape, and a plurality of second grooves 32 are formed on an upper surface of the second protruding portion 22. The plurality of second grooves 32 extend in parallel to the longitudinal direction of the base 20, and are arranged along the lateral direction of the base 20, for example. A pitch P2 of the plurality of second grooves 32 is larger than the pitch P1 of the plurality of first grooves 31, and is in a range of 200 μm to 300 μm, for example. A cross sectional shape of the second groove 32 is a V-shape having two sloping surfaces, for example.

The number of the optical fibers 90, the number of the first grooves 31, and the number of the second grooves 32 are not particularly limited, respectively, and may all be twelve, for example. For example, a first set of six first grooves 31 and six second grooves 32 and another, second set of six first grooves 31 and six second grooves 32 are disposed in line symmetry with respect to an axis parallel to the longitudinal direction of the base 20.

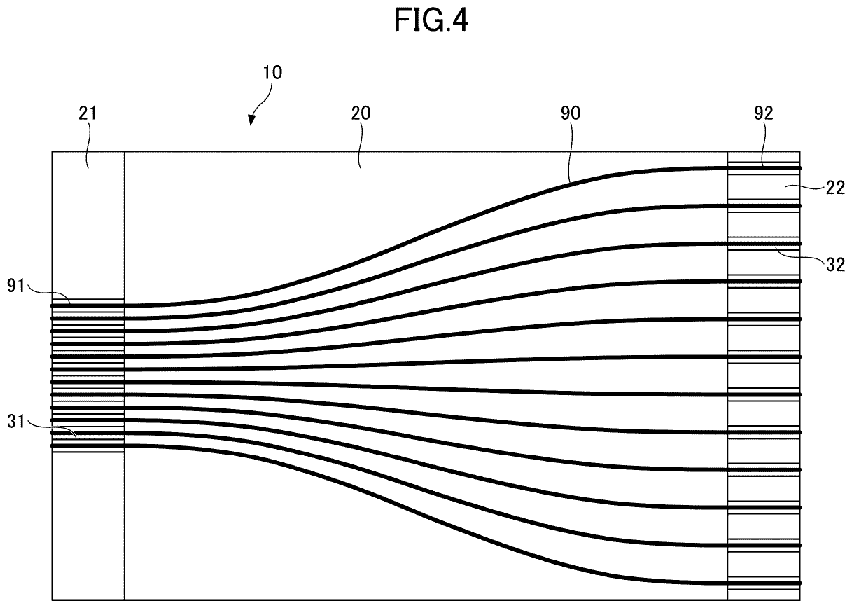

FIG. 4 is a plan view illustrating examples of the support member 11 and the optical fibers 90 according to the first embodiment. The plurality of optical fibers 90 have first ends 91, and second ends 92 opposite to the first ends 91. The first ends 91 of the plurality of optical fibers 90 are accommodated in the plurality of first grooves 31, respectively. The second ends 92 of the plurality of optical fibers 90 are accommodated in the plurality of second grooves 32, respectively. The plurality of optical fibers 90 do not intersect each other between the first protruding portion 21 and the second protruding portion 22.

The organic resin layer 40 is provided on an upper surface of the support member 11. The plurality of optical fibers 90 are encapsulated by the organic resin layer 40. The organic resin layer 40 includes a first adhesive portion 41 and a second adhesive portion 42. The first adhesive portion 41 adheres the plurality of first ends 91 to the plurality of first grooves 31, respectively, and the second adhesive portion 42 adheres the plurality of second ends 92 to the plurality of second grooves 32, respectively. The plurality of first ends 91 are fixed to the first protruding portion 21 by the first adhesive portion 41, and the plurality of second ends 92 are fixed to the second protruding portion 22 by the second adhesive portion 42. The organic resin layer 40 is formed of a cured ultraviolet curable resin, for example.

The first cover 51 is provided on the first protruding portion 21 and the plurality of first ends 91. The first cover 51 has a rectangular parallelepiped shape including a second surface 51A facing the plurality of first grooves 31. An outer edge of the first cover 51 and an outer edge of the first protruding portion 21 overlap each other in the plan view. The first adhesive portion 41 is also provided between the first protruding portion 21 and the first cover 51, and the first cover 51 is adhered to the support member 11 by the first adhesive portion 41.

The second cover 52 is provided on the second protruding portion 22 and the plurality of second ends 92. The second cover 52 has a rectangular parallelepiped shape including a third surface 52A facing the plurality of second grooves 32. An outer edge of the second cover 52 and an outer edge of the second protruding portion 22 overlap each other in the plan view. The second adhesive portion 42 is also provided between the second protruding portion 22 and the second cover 52, and the second cover 52 is adhered to the support member 11 by the second adhesive portion 42.

An end surface of the support member 11 on the side closer to the first protruding portion 21, end surfaces of the plurality of first ends 91 of the plurality of optical fibers 90, and an end surface of the first cover 51 are aligned to one another. An end surface of the support member 11 on the side closer to the second protruding portion 22, end surfaces of the plurality of second ends 92 of the plurality of optical fibers 90, and an end surface of the second cover 52 are aligned to one another.

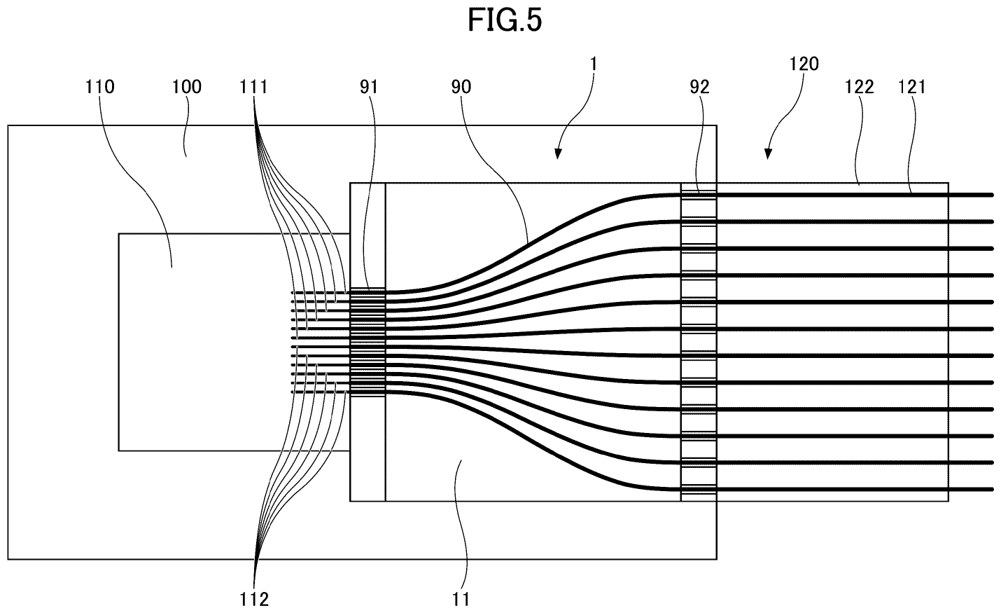

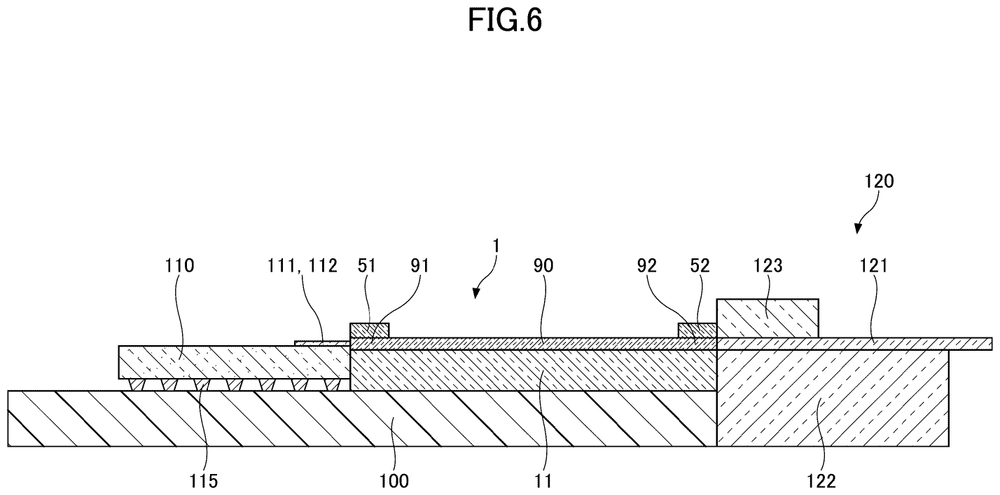

Next, a usage of the optical waveguide component 1 will be described. FIG. 5 is a plan view illustrating an example of the usage of the optical waveguide component 1 according to the first embodiment. FIG. 6 is a cross sectional view illustrating the example of the usage of the optical waveguide component 1 according to the first embodiment.

As illustrated in FIG. 5 and FIG. 6, the optical waveguide component 1 is provided on a substrate 100, for example. The optical waveguide component 1 is fixed to the substrate 100 using an ultraviolet curable adhesive (not illustrated), for example. The substrate 100 is a printed wiring board, for example. An optical semiconductor device 110 is also provided on the substrate 100. The optical semiconductor device 110 is configured using silicon photonics, for example. The optical semiconductor device 110 includes a plurality of electrodes 115, and is flip-chip bonded to the substrate 100. The optical semiconductor device 110 includes a plurality of light emitting parts 111 and a plurality of light receiving parts 112. The number of the light emitting parts 111 and the number of the light receiving parts 112 are not particularly limited, respectively, and may be six each, for example. The optical semiconductor device 110 may be a semiconductor laser.

The optical semiconductor device 110 and the optical waveguide component 1 are disposed such that the plurality of light emitting parts 111 and the plurality of light receiving parts 112 face one-to-one with the plurality of first ends 91. That is, each light emitting part 111 faces one first end 91 of the plurality of first ends 91, and each light receiving part 112 faces one first end 91 of the plurality of first ends 91. The plurality of light emitting parts 111 and the plurality of light receiving parts 112 are disposed along the lateral direction of the base 20, for example. A pitch of the plurality of light emitting parts 111 and the plurality of light receiving parts 112 is equal to the pitch P1.

An optical fiber array 120 is connected to the optical waveguide component 1 on the side opposite from the optical semiconductor device 110. The optical fiber array 120 includes a plurality of optical fibers 121, a support member 122, and a third cover 123. For example, the support member 122 and the third cover 123 are formed of glass, such as quartz glass or the like. A diameter of the optical fiber 121 may be equal to the diameter of the optical fiber 90, or may be larger than the diameter of the optical fiber 90. A diameter of a core of optical fiber 121 is preferably equal to the diameter of the core 96 of optical fiber 90.

The optical waveguide component 1 and the optical fiber array 120 are arranged such that the plurality of second ends 92 face one-to-one with the plurality of optical fibers 121. The plurality of optical fibers 121 are disposed along the lateral direction of the base 20, for example, and a pitch of the plurality of optical fibers 121 on the support member 122 is equal to the pitch P2.

The third cover 123 is provided on the support member 122 and the plurality of optical fibers 121. The third cover 123 is bonded to the support member 122 using a bonding portion (not illustrated) formed of a cured ultraviolet curable resin, with the plurality of optical fibers 121 interposed between the third cover 123 and the support member 122.

In FIG. 5, the illustration of the organic resin layer 40, the first cover 51, the second cover 52, and the third cover 123 is omitted for the sake of convenience.

Because the plurality of optical fibers 90 included in the optical waveguide component 1 are formed of glass, it is possible to reduce a transmission loss when compared to an optical waveguide component using an optical waveguide formed of an organic resin. The transmission loss of the optical fiber 90 formed of glass is approximately 2 dB/km, whereas the transmission loss of the optical waveguide formed of the organic resin is 0.5 dB/cm. Further, the optical waveguide component 1 is less likely to become deteriorated even under a high-temperature and high-humidity environment, when compared to the optical waveguide component using the optical waveguide formed of the organic resin. Accordingly, an excellent long-term reliability can be obtained for the optical waveguide component 1 even under a high temperature and high humidity testing or the like.

In a case where the diameter of the core 96 of the optical fiber 90 is equal to the diameter of the core of the optical fiber 121, it is possible to particularly reduce a connection loss and a reflection loss between the optical fiber 90 and the optical fiber 121. Even in a case where the diameter of the core 96 of the optical fiber 90 is not equal to the diameter of the core of the optical fiber 121, it is possible to reduce the connection loss and the reflection loss if a difference between the diameters is small. On the other hand, because the optical waveguide formed of the organic resin is configured through patterning or the like, it is extremely difficult to make the cross sectional shape of the core of the optical waveguide formed of the organic resin circular. Accordingly, by using the optical fiber 90 having a circular cross sectional shape, the connection loss and the reflection loss between the optical fiber 90 and the optical fiber 121 can easily be reduced when compared to the optical waveguide component using the optical waveguide formed of the organic resin.

Next, a method for manufacturing the optical waveguide component 1 will be described.

First, the plurality of optical fibers 90, the support member 11, the first cover 51, and the second cover 52 are prepared. The plurality of optical fibers 90 that are prepared are longer than a length of a completed optical waveguide component 1. Next, the plurality of optical fibers 90 are attached to the support member 11 so as to be accommodated in the first grooves 31 and the second grooves 32. Thereafter, an adhesive is coated on the upper surface of the support member 11 so as to cover the plurality of optical fibers 90. For example, an ultraviolet curable adhesive can be used for the adhesive. Next, the first cover 51 is pressed against the first protruding portion 21 and the plurality of first ends 91 from above, and the second cover 52 is pressed against the second protruding portion 22 and the plurality of second ends 92 from above, while curing the adhesive to thereby form the organic resin layer 40. Next, the end surface of the support member 11 on the side closer to the first protruding portion 21, the end surfaces of the plurality of first ends 91 of the plurality of optical fibers 90, and the end surface of the first cover 51 are simultaneously polished. In addition, the end surface of the support member 11 on the side closer to the second protruding portion 22, the end surfaces of the plurality of second ends 92 of the plurality of optical fibers 90, and the end surface of the second cover 52 are simultaneously polished.

The optical waveguide component 1 can be manufactured in the manner described above.

According to such a manufacturing method, at a stage before the adhesive is provided, a stress caused by the restraint by the first protruding portion 21 and the second protruding portion 22 acts on portions of the plurality of optical fibers 90 between the first protruding portion 21 and the second protruding portion 22, but other stresses substantially do not act on the plurality of optical fibers 90. Moreover, even after the organic resin layer 40 is formed, the shape of each optical fiber 90 of the plurality of optical fibers 90 does not change from the shape before the adhesive is provided. Accordingly, the stress acting on the plurality of optical fibers 90 can be reduced to a low value.

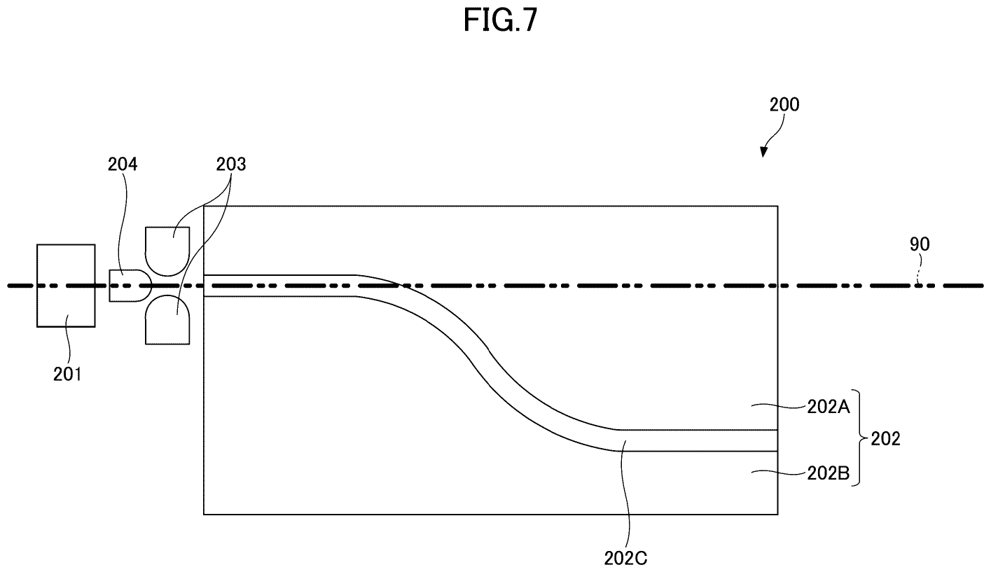

When attaching the plurality of optical fibers 90 to the support member 11, an attachment tool 200 described hereunder may be used. FIG. 7 is a plan view illustrating an example of the attachment tool 200 used when attaching the plurality of optical fibers 90 to the support member 11.

The attachment tool 200 includes a fixing jig 201, an alignment jig 202, a slide guide 203, and a pressing jig 204.

The fixing jig 201 pinches one end of the optical fiber 90 and fixes a position of the one end with respect to a predetermined first groove 31.

The alignment jig 202 has guide plates 202A and 202B, and a gap 202C slightly larger than the diameter of the optical fiber 90 is provided between the guide plate 202A and the guide plate 202B. The alignment jig 202 is disposed between the first protruding portion 21 and the second protruding portion 22, and one end of the gap 202C is connected to the first groove 31 for attaching the optical fiber 90, and the other end of the gap 202C is connected to the second groove 32 for attaching the optical fiber 90. In a case where twelve optical fibers 90 are to be attached to the support member 11, 6 kinds of alignment jigs 202 are used, for example.

The slide guide 203 is configured to be movable along two axes parallel to the first surface 20A of the base 20. The slide guide 203 slidably pinches the optical fiber 90 in a direction parallel to the first surface 20A. By moving the slide guide 203, the portion of the optical fiber 90 pinched by the slide guide 203 can be moved along the gap 202C.

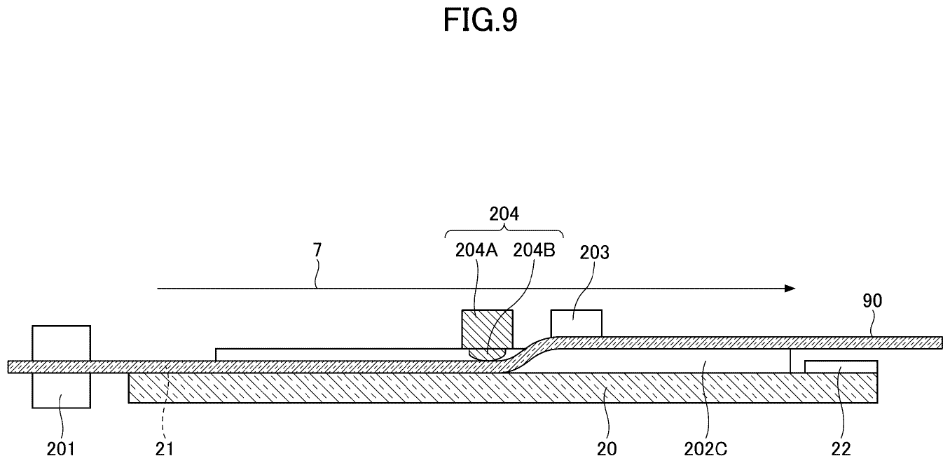

The pressing jig 204 presses the optical fiber 90 toward the support member 11. The pressing jig 204 includes a base 204A that makes contact with upper surfaces of the guide plates 202A and 202B, and a pressing portion 204B that enters the gap 202C from the base 204A and presses against the optical fiber 90 (refer to FIG. 9), for example. The pressing jig 204 is provided on the side of the slide guide 203 closer to the fixing jig 201, and is configured to be movable integrally with the slide guide 203.

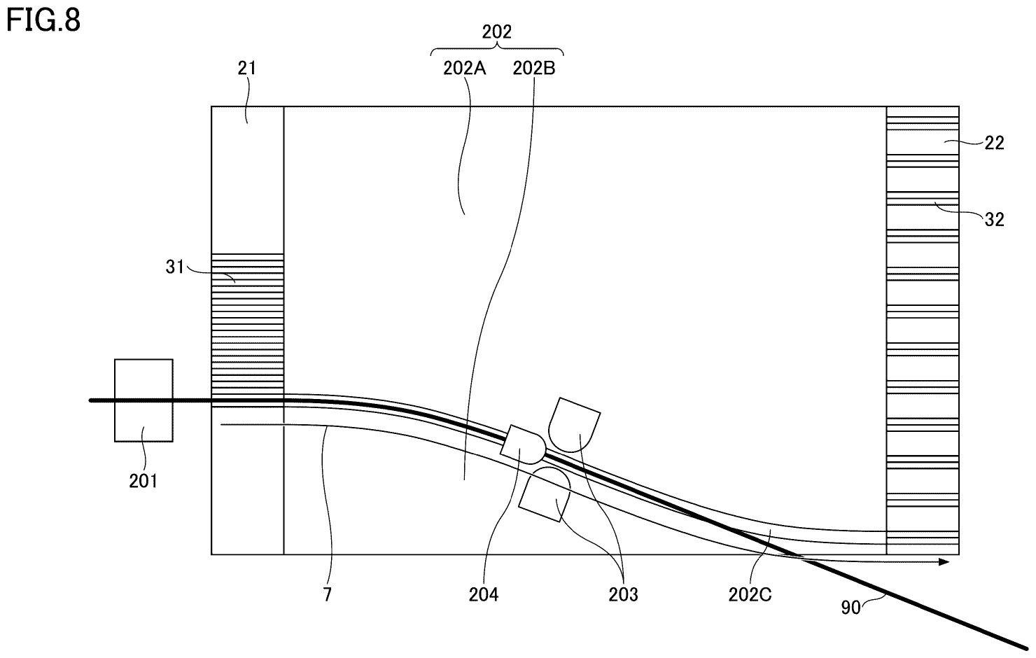

Next, a method of attaching the optical fiber 90 using the attachment tool 200 will be described. FIG. 8 is a plan view illustrating an example of the method of attaching the optical fiber 90 using the attachment tool 200. FIG. 9 is a cross sectional view illustrating the example of the method of attaching the optical fiber 90 using the attachment tool 200. FIG. 8 and FIG. 9 illustrate a stage in the middle of the process of attaching the optical fiber 90 to the support member 11 using the attachment tool 200.

First, the guide plates 202A and 202B are disposed so that the gap 202C is continuous with the first groove 31 and the second groove 32, and positions of the guide plates 202A and 202B are fixed by a tool (not illustrated) or the like. In addition, one end of the optical fiber 90 is pinched by the fixing jig 201, and a position of the fixing jig 201 is fixed by a jig (not illustrated) or the like. Next, as illustrated by an arrow 7 in FIG. 8 and FIG. 9, the slide guide 203 and the pressing jig 204 are moved from a vicinity of the fixing jig 201 along the first groove 31, the gap 202C, and the second groove 32. As a result, the optical fiber 90 is successively pushed into the first groove 31, the gap 202C, and the second groove 32 by the pressing jig 204. The optical fiber 90 can be attached to the support member 11 in this manner.

It is preferable to maintain the state in which the optical fiber 90 is accommodated in the first groove 31, using a temporary fixing plate (not illustrated) or the like so that the optical fiber 90 does not separate from the first groove 31 after the optical fiber 90 is pushed into the first groove 31.

### Second Embodiment

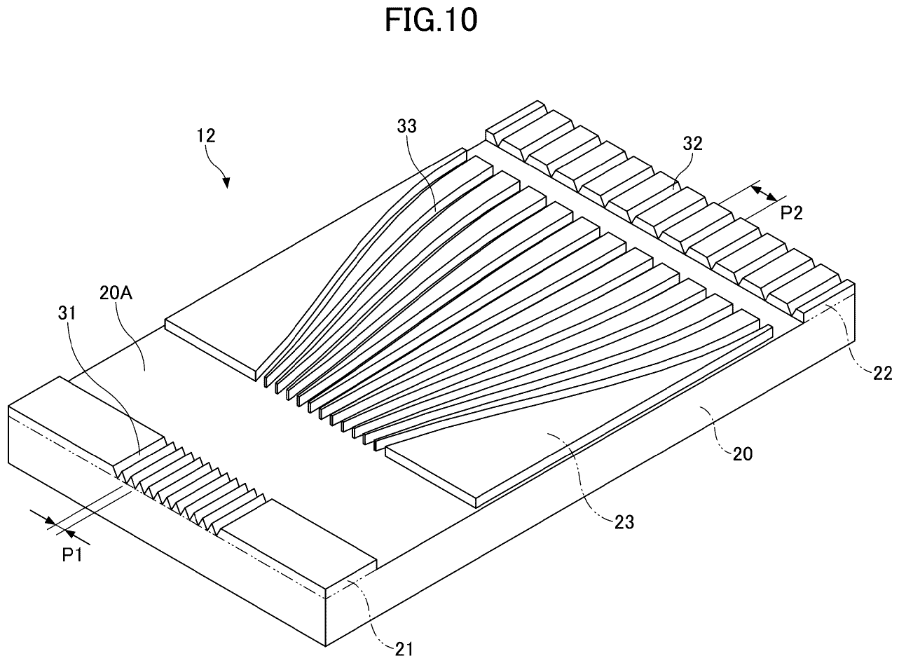

Next, a second embodiment will be described. The second embodiment differs from the first embodiment mainly in the configuration of the support member. FIG. 10 is a perspective view illustrating an example of the support member according to the second embodiment.

The optical waveguide component according to the second embodiment includes a support member 12 in place of the support member 11. The support member 12 includes a base 20, a first protruding portion 21, and a second protruding portion 22, similar to the support member 11. The support member 12 further includes a guide portion 23. The guide portion 23 is provided on a first surface 20A of the base 20 between the first protruding portion 21 and the second protruding portion 22. The guide portion 23 is separated from the first protruding portion 21 and the second protruding portion 22. A plurality of third grooves 33 are formed in the guide portion 23. The number of the third grooves 33 is equal to the number of the first grooves 31 and the number of the second grooves 32. Each third groove 33 of the plurality of third grooves 33 faces a pair of first groove 31 and second groove 32.

The other configurations of the second embodiment are the same as those of the first embodiment.

In the second embodiment, each optical fiber 90 of the plurality of optical fibers 90 is accommodated not only in the first groove 31 and the second groove 32 but also in the third groove 33. Accordingly, the optical fiber 90 can easily be attached to the support member 12.

A stress from the guide portion 23 may act on the optical fiber 90, but because the guide portion 23 is separated from the first groove 31 and the second groove 32, it is possible to reduce the stress acting on the optical fiber 90 to a low value.

Although the preferred embodiments are described in above detail, the present disclosure is not limited to the embodiments described above, and various variations, modifications, and substitutions can be made to the embodiments described above without departing from the scope of the present disclosure.

According to the present disclosure, it is possible to reduce a loss of an optical signal.

Although the embodiments are numbered with, for example, “first,” or “second,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide component comprising:
a plurality of optical fibers, each optical fiber of the plurality of optical fibers having a first end and a second end; and
a support member configured to support the plurality of optical fibers,
the support member including:
a base including a first surface;
a first protruding portion protruding from the first surface in a first direction perpendicular to the first surface; and
a second protruding portion protruding from the first surface in the first direction at a position separated from the first protruding portion, wherein:
the first protruding portion includes a plurality of first grooves respectively configured to accommodate the first end of each optical fiber of the plurality of optical fibers,
the second protruding portion includes a plurality of second grooves respectively configured to accommodate the second end of each optical fiber of the plurality of optical fibers, and
a pitch of the plurality of second grooves is larger than a pitch of the plurality of first grooves.

2. The optical waveguide component as claimed in claim 1, wherein each optical fiber of the plurality of optical fibers has a diameter of 80 μm or less.

3. The optical waveguide component as claimed in claim 1, wherein the support member is formed of glass.

4. The optical waveguide component as claimed in claim 1, further comprising:
a first adhesive portion configured to adhere the first end of each optical fiber of the plurality of optical fibers to each first groove of the plurality of first grooves; and
a second adhesive portion configured to adhere the second end of each optical fiber of the plurality of optical fibers to each second groove of the plurality of second grooves.

5. The optical waveguide component as claimed in claim 4, further comprising:
a first cover having a second surface facing the plurality of first grooves and adhered to the support member by the first adhesive portion;
a second cover having a third surface facing the plurality of second grooves and adhered to the support member by the second adhesive portion.

6. The optical waveguide component as claimed in claim 1, further comprising:
a guide portion provided on the first surface between the first protruding portion and the second protruding portion,
wherein the guide portion includes a plurality of third grooves configured to accommodate the plurality of optical fibers.
